(19) United States
(12) Patent Application Publication
(10) Pub. No.: US 2018/0284920 A1
(43) Pub. Date: Oct. 4, 2018

(54) TRANSFER-TYPE PHOTOSENSITIVE FILM FOR REFRACTIVE-INDEX MODULATION

(71) Applicant: HITACHI CHEMICAL COMPANY, LTD., Tokyo (JP)

(72) Inventors: Kazuhito WATANABE, Chiyoda-ku, Tokyo (JP); Tadahiro KIMURA, Chiyoda-ku, Tokyo (JP); Mayumi SATO, Chiyoda-ku, Tokyo (JP); Takumi WATANABE, Chiyoda-ku, Tokyo (JP)

(21) Appl. No.: 15/764,722

(22) PCT Filed: Sep. 30, 2015
(86) PCT No.: PCT/JP2015/004986

§ 371 Date: Mar. 29, 2018

(51) Int. Cl. G06F 3/044; B32B 7/02; B32B 27/20; B32B 27/30

(52) U.S. Cl. CPC G06F 3/044; B32B 7/02; B32B 27/20; G06F 2203/04103; B32B 2307/418; B32B 2457/208; G06F 2203/04107; B32B 27/308

(57) ABSTRACT

A transfer type photosensitive film for refractive index modulation which has a supporting film, a photosensitive resin layer disposed on the supporting film, and a high refractive index layer disposed on the photosensitive resin layer and containing zirconium oxide and tin oxide.

### TECHNICAL FIELD

The present invention relates to a transfer type photosensitive film for refractive index modulation.

### BACKGROUND ART

In a display device including a large-sized electronic device such as PCs or TVs, a small-sized electronic device such as a car navigation, a portable phone, or an electronic dictionary, an OA device, or FA device, a liquid crystal display device or a touch panel (touch sensor) is used. In these liquid crystal display devices or touch panels, an electrode made of a transparent electrode material is provided. As the transparent electrode material, indium-tin-oxide (ITO), indium oxide or tin oxide constitutes the mainstream thereof from the viewpoint that they exhibit high transmittance for visible rays.

As the touch panel, various types of touch panel have already been put into practical use. Since it enables finger tips to conduct multiple detection, a projection type capacitive touch panel has excellent operability that it can issue complicated instructions. Due to such reasons, in a device having a small-sized display such as a portable phone or a portable music player, use of a projection type capacitive touch panel as an input device on a display screen has been actively developed.

In general, in a projection type capacitive touch panel, in order to express two-dimensional coordinates of the X-axis and the Y-axis, plural X electrodes and plural Y electrodes that cross orthogonally the X electrodes form a two-layer structure pattern. As these electrodes, in recent years, use of conductive fibers that are represented by Ag nanowires, carbon nanotubes, or the like has been examined. However, ITO still constitutes the mainstream.

Meanwhile, in order to transmit detected signals of touch positions, metal wiring is required to be provided in a frame area of a touch panel. From the viewpoint of conductivity, the metal wiring is generally formed of copper.

When a touch panel is brought into contact with the finger tips, corrosive components such as moisture or salt may invade into the inside from a sensing area. If corrosive components invade into the inside of a touch panel, the aforementioned metal wiring corrodes, and as a result, an electrical resistance between an electrode and a driving circuit may be increased or disconnection may occur.

In order to prevent corrosion of metal wiring, the inventors of the present invention suggest a method of protecting the metal wiring on a transparent substrate by providing a photosensitive layer formed of a specific photosensitive resin composition on a transparent substrate and subjecting the photosensitive layer to light exposure and development (see, Patent Literature 1, for example).

However, in a projection type capacitive touch panel as mentioned above, by transparent electrode materials on a substrate, plural X electrodes and plural Y electrodes that cross orthogonally to the X electrodes made of transparent electrode materials are formed, thereby to form a transparent electrode pattern having a two-layer structure. However, a difference in color becomes large due to optical reflection of a part in which a transparent electrode pattern is formed and a part in which a transparent electrode pattern is not formed. As a result, when it is formed into a module, there is a problem of so-called “visible skeleton phenomenon” in which a transparent electrode pattern is pictured in a screen may occur. Furthermore, between a substrate and a transparent electrode or between a recognizability improvement film (OCA: Optical Clear Adhesive) that adheres a cover glass used for forming a module and a transparent electrode pattern, there is a problem that the intensity of reflected light is increased to lower the transmittance of a screen.

The method described in the above Patent Literature 1 is effective in terms of protecting a metal wiring. However, there is a room for improvement in terms of suppressing the visible skeleton phenomenon or suppressing a decrease in screen transmittance.

Furthermore, as a technique for preventing the recognizability of a transparent electrode pattern, a transfer film having a first curable transparent resin layer with low refractive index and a second curable transparent resin layer with high refractive index, which are adjusted to have refractive index within a specific range and present so as to be adjacent to each other, is disclosed (see, Patent Literature 2, for example).

### CITATION LIST

### Patent Literature

Patent Literature 1: International Publication No. 2013/084873 pamphlet

Patent Literature 2: International Publication No. 2014/084112 pamphlet

### SUMMARY OF INVENTION

However, from the viewpoint of forming a cured film for obtaining both the suppression of a decrease in screen transmittance and protection of a sensor metal wiring, the technique of Patent Literature 2 has a room for improvement due to an insufficient development property during forming of a certain cured film. Furthermore, although a six-layer film consisting of a temporary supporting body/a thermoplastic resin layer/an intermediate layer/a first curable transparent resin layer/a second curable transparent resin layer/a protective film is disclosed as a specific constitution of a transfer film, there is still a room for improvement from the viewpoint of the productivity of multilayer film.

Furthermore, according to the technique of Patent Literature 2, high refractive index is exhibited by coating a dispersion of zirconium oxide as ultrafine metal oxide particles after mixing it with a binder resin (Examples, claim 9, and the like). However, there is a problem that, when the zirconium oxide dispersion (ZR-010) manufactured by Solar Co., Ltd. is used as described in Patent Literature 2, the development property is insufficient so that an IM layer remains as residues on a metal wiring part and the residues become a cause of having poor connection among circuits.

Object of the present invention is to provide a transfer type photosensitive film for refractive index modulation that can attain both the suppression of a visible skeleton phenomenon of a transparent electrode pattern or suppression of a decrease in screen transmittance and the protection of a sensor metal wiring, and also enable easy forming of a cured film with excellent development property.

The inventors of the present invention conducted intensive studies to solve the aforementioned problems. As a result, the inventors have found that, by forming a thin IM layer on a transparent conductive pattern by using a transfer type photosensitive film for refractive index modulation composed of a photosensitive resin layer and a high refractive index layer, an increase in difference in color is suppressed, and thus an improvement of the recognizability of a touch screen by suppression of the visible skeleton phenomenon and suppression of a decrease in screen transmittance and suppression of corrosion of a metal wiring can be attained simultaneously. It is further found that the development property can be enhanced by using a specific material for the high refractive index layer, and the present invention is completed accordingly.

The specific aspects of the present invention are described below.

1. A transfer type photosensitive film for refractive index modulation which has a supporting film, a photosensitive resin layer disposed on the supporting film, and a high refractive index layer disposed on the photosensitive resin layer and containing zirconium oxide and tin oxide.

2. A transfer type photosensitive film for refractive index modulation which has a supporting film, a photosensitive resin layer disposed on the supporting film, and a high refractive index layer disposed on the photosensitive resin layer and containing zirconium oxide and silica.

3. The transfer type photosensitive film for refractive index modulation described in 1 or 2, in which the high refractive index layer contains zirconium oxide, tin oxide, and silica.

4. The transfer type photosensitive film for refractive index modulation described in any one of 1 to 3, in which the refractive index at 633 nm of the high refractive index layer is 1.5 to 1.9.

5. The transfer type photosensitive film for refractive index modulation described in any one of 1 to 4, in which the film thickness of the high refractive index layer is 50 nm to 500 nm.

6. The transfer type photosensitive film for refractive index modulation described in any one of 1 to 5, in which the photosensitive resin layer contains a binder polymer, a photopolymerizable compound, and a photopolymerization initiator.

7. The transfer type photosensitive film for refractive index modulation described in 6, in which the photopolymerization initiator contains an oxime ester compound.

8. The transfer type photosensitive film for refractive index modulation described in 6 or 7, in which the binder polymer is a polymer having a carboxy group.

9. The transfer type photosensitive film for refractive index modulation described in any one of 6 to 8, in which the binder polymer is a polymer which contains a structural unit derived from a compound selected from (meth)acrylic acid, (meth)acrylic acid glycidyl ester, (meth)acrylic acid benzyl ester, styrene, (meth)acrylic acid methyl ester, (meth)acrylic acid ethyl ester, (meth)acrylic acid butyl ester, and (meth)acrylic acid-2-ethylhexyl ester.

10. The transfer type photosensitive film for refractive index modulation described in any one of 1 to 9, in which the photosensitive resin layer contains phosphoric acid ester including a photopolymerizable unsaturated bond.

11. The transfer type photosensitive film for refractive index modulation described in any one of 1 to 10, in which the minimum value of visible ray transmittance at 400 to 700 nm of a laminate with the photosensitive resin layer and the high refractive index layer is 90% or higher.

12. The transfer type photosensitive film for refractive index modulation described in any one of 1 to 11, in which the total thickness of the photosensitive resin layer and the high refractive index layer is 30 μm or less.

13. A method for forming a refractive index modulating pattern, including:

a step of laminating a high refractive index layer and a photosensitive resin layer by using the transfer type photosensitive film for refractive index modulation described in any one of 1 to 12 such that the high refractive index layer is closely adhered on a substrate, and

a step of exposing predetermined parts of the high refractive index layer and the photosensitive resin layer on the substrate, and removing parts other than the predetermined parts to form a refractive index modulating pattern.

14. A laminate having, a high refractive index layer containing zirconium oxide and tin oxide, and a photosensitive resin layer, on a substrate with electrode pattern.

15. A laminate having, a high refractive index layer containing zirconium oxide and silica, and a photosensitive resin layer, on a substrate with electrode pattern.

16. An electronic component having, a pattern consisting of a high refractive index layer containing zirconium oxide and tin oxide, and a pattern consisting of a cured film of a photosensitive resin layer, on a substrate with electrode pattern.

17. An electronic component having, a pattern consisting of a high refractive index layer containing zirconium oxide and silica, and a pattern consisting of a cured film of a photosensitive resin layer, on a substrate with electrode pattern.

According to the present invention, a transfer type photosensitive film for refractive index modulation that can attain both functions of suppressing a visible skeleton phenomenon of a transparent electrode pattern or suppressing a decrease in screen transmittance, and protecting a sensor metal wiring, and also enable easy forming of a cured film with excellent development property can be provided.

### BRIEF DESCRIPTION OF DRAWINGS

FIG. 1 is a schematic cross-sectional view illustrating the transfer type photosensitive film for refractive index modulation of the present invention.

FIG. 2 is a schematic cross-sectional view illustrating one embodiment in which the transfer type photosensitive film for refractive index modulation of the present invention is used for a substrate adhered with a transparent conductive pattern.

FIG. 3 is a schematic plan view illustrating an electronic component according to one embodiment of the present invention.

### DESCRIPTION OF EMBODIMENTS

Hereinbelow, the mode for carrying out the present invention will be explained in detail. However, the present invention is not limited to the embodiments mentioned below. Furthermore, in the specification, the “(meth)acrylic acid” means an acrylic acid or a methacrylic acid, and the “(meth)acrylate” means acrylate or methacrylate corresponding thereto. The “(poly)oxyethylene chain” means an oxyethylene group or a polyoxyethylene group. The “(poly)oxypropylene chain” means an oxypropylene group or a polyoxypropylene group. The “A or B” means that either one of A and B may be included, and it is also possible that both are included.

Furthermore, in the specification, the “step” includes not only an independent step. That is, if a step cannot be clearly distinguished from other steps, the step is included in this term as long as the step attains its predetermined effects. Furthermore, the numerical range indicated by using “to” means a range including numerical values indicated before and after the “to” as a minimum value and a maximum value, respectively.

Furthermore, as for the content of each component in the composition in the specification, when plural substances corresponding to each component are present in the composition, unless mentioned specifically otherwise, the content means the total amount of those plural substances present in the composition. In addition, unless mentioned specifically otherwise, exemplified materials may be used singly or in combination of two or more.

(Transfer Type Photosensitive Film for Refractive Index Modulation)

The present invention relates to a transfer type photosensitive film for refractive index modulation which has a supporting film, a photosensitive resin layer disposed on the supporting film, and a high refractive index layer disposed on the photosensitive resin layer.

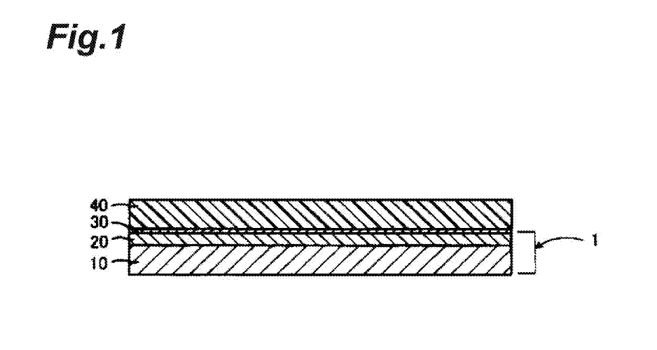

FIG. 1 is a schematic cross-sectional view illustrating one embodiment of the transfer type photosensitive film for refractive index modulation of the present invention. A transfer type photosensitive film for refractive index modulation 1 illustrated in FIG. 1 is provided with a supporting film 10, a photosensitive resin layer 20 disposed on the supporting film, and a high refractive index layer 30 disposed on the photosensitive resin layer. Furthermore, the transfer type photosensitive film for refractive index modulation may include a protective film 40 disposed on the side opposite to the supporting film 10 of the photosensitive resin layer 20, as illustrated in FIG. 1.

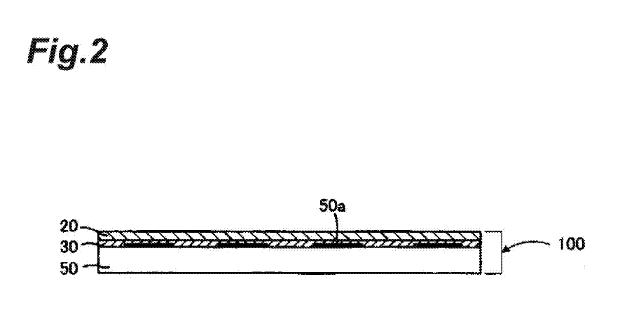

FIG. 2 is a schematic cross-sectional view illustrating one embodiment in which the transfer type photosensitive film for refractive index modulation of the present invention is used in a substrate adhered with a transparent conductive pattern. In FIG. 2, on a substrate 50 adhered with a transparent electrode pattern 50a like ITO, the high refractive index layer 30 is provided so that it can cover the pattern 50a, and, on the high refractive index layer 30, the photosensitive resin layer 20 is provided to constitute a laminate 100.

By using the aforementioned transfer type photosensitive film for refractive index modulation, it becomes possible to form in a batch mode a cured film which satisfies both the function of protecting a metal wire or a transparent electrode within a frame of a touch panel and the function of suppressing the visualization of a transparent electrode pattern or enhancing the recognizability of a touch screen.

As the supporting film 10, a polymer film can be used. As the polymer film, polyethylene terephthalate, polycarbonate, polyethylene, polypropylene, polyether sulfone, cycloolefin polymer or the like can be mentioned.

Thickness of the supporting film 10 is, from the viewpoint of having the coating property and suppressing a decrease in resolution when irradiating active rays through the supporting film 10, preferably 5 to 100 μm, more preferably 10 to 70 μm, even more preferably 15 to 40 μm, and particularly preferably 15 to 35 μm.

(Photosensitive Resin Layer)

It is preferred that the photosensitive resin layer 20 is fainted of a photosensitive resin composition containing a binder polymer (hereinbelow, also referred to as component (A)), a photopolymerizable compound (hereinbelow, also referred to as component (B)), and a photopolymerization initiator (hereinbelow, also referred to as component (C)).

As the component (A), from the viewpoint of enabling patterning by alkali development, it is preferable to use a polymer having a carboxy group.

As the component (A), a copolymer containing constitutional units derived from (meth)acrylic acid or (meth)acrylic acid alkyl ester is preferable. This copolymer may contain, as its constitutional unit, other monomers that can copolymerize with the (meth)acrylic acid and (meth)acrylic acid alkyl ester. Specifically, (meth)acrylic acid glycidyl ester, (meth)acrylic acid benzyl ester, styrene, dicyclopentanyl (meth)acrylate, dicyclopentenyloxyethyl (meth)acrylate or the like can be mentioned. Furthermore, it is also possible that the component (A) has a radical polymerizable double bond.

As the aforementioned (meth)acrylic acid ester, (meth)acrylic acid methyl ester, (meth)acrylic acid ethyl ester, (meth)acrylic acid butyl ester, (meth)acrylic acid-2-ethylhexyl ester, (meth)acrylic acid hydroxyl ethyl ester or the like can be mentioned.

Among them, from the viewpoint of an alkali development property, in particular, an alkali development property for an inorganic aqueous alkaline solution, patterning property, or a transparency, a binder polymer consisting of a structural unit of a compound that is selected from (meth)acrylic acid, (meth)acrylic acid glycidyl ester, (meth)acrylic acid benzyl ester, styrene, (meth)acrylic acid methyl ester, (meth)acrylic acid ethyl ester, (meth)acrylic acid butyl ester, and (meth)acrylic acid-2-ethylhexyl ester is preferable.

From the viewpoint of resolution, the weight average molecular weight of the component (A) is preferably 10,000 to 200,000, more preferably 15,000 to 150,000, even more preferably 30,000 to 150,000, and particularly preferably 30,000 to 100,000, with 40,000 to 100,000 being significantly preferable. Furthermore, the weight average molecular weight can be measured by a gel permeation chromatography method with reference to Examples of the present specification.

The acid value of the component (A) is preferably 75 mgKOH/g or more from the viewpoint of forming a protective film having a desired shape easily by alkali development. Furthermore, from the viewpoint of attaining both easiness in control of the shape of a protective film and rust prevention of a protective film, the acid value is preferably 75 to 200 mgKOH/g, more preferably 75 to 150 mgKOH/g, and even more preferably 75 to 120 mgKOH/g. Furthermore, the acid value can be measured with reference to Examples of the present specification.

From the viewpoint of further improving rust prevention property, the hydroxyl value of the component (A) is preferably 50 mgKOH/g or lower, and more preferably 45 mgKOH/g or lower. Furthermore, the hydroxyl value can be measured with reference to Examples of the present specification.

As the component (B), a photopolymerizable compound having an ethylenically unsaturated group can be used. As the photopolymerizable compound having an ethylenically unsaturated group, a monofunctional vinyl monomer, a bifunctional vinyl monomer, or a polyfunctional vinyl monomer having at least three polymerizable ethylenically unsaturated groups can be mentioned.

The compound used as the component (B) may be overlapped with the component (A), but it is a component other than the component (A) (component different from the component (A)).

As the monofunctional vinyl monomer, for example, those exemplified above as the monomer used for the synthesis of a copolymer that is a preferable example of the component (A) can be mentioned.

As the bifunctional vinyl monomer, polyethylene glycol di(meth)acrylate, trimethylol propane di(meth)acrylate, polypropylene glycol di(meth)acrylate, 2,2-bis(4-(meth)acryloxypolyethoxypolypropoxyphenyl)propane, bisphenol A diglycidyl ether di(meth)acrylate, tricyclodecane dimethanol diacrylate, or the like can be mentioned.

As the polyfunctional vinyl monomer having at least three ethylenically polymerizable unsaturated groups, conventionally known ones can be used without any particular limitation. From the viewpoint of suppressing corrosion of the metal wiring or the transparent electrode and the development property, it is preferable to use a (meth)acrylate compound having a skeleton derived from trimethylol propane such as trimethylol propane tri(meth)acrylate; a (meth)acrylate compound having a skeleton derived from tetramethylol methane such as tetramethylol methane tri(meth)acrylate or tetramethylol methane tetra(meth)acrylate; a (meth)acrylate compound having a skeleton derived from pentaerythritol such as pentaerythritol tri(meth)acrylate or pentaerythritol tetra(meth)acrylate; a meth(acrylate) compound having a skeleton derived from dipentaerythritol such as dipentaerythritol penta(meth)acrylate or dipentaerythritol hexa(meth)acrylate; a (meth)acrylate compound having a skeleton derived from ditrimethylol propane such as ditrimethylol propane tetra(meth)acrylate; or a (meth)acrylate compound having a skeleton derived from diglycerin.

More specifically, it is preferable to include a (meth)acrylate compound having a skeleton derived from pentaerythritol, a (meth)acrylate compound having a skeleton derived from dipentaerythritol, a (meth)acrylate compound having a skeleton derived from trimethylol propane, or a (meth)acrylate compound having a skeleton derived from ditrimethylol propane. It is more preferable to include a (meth)acrylate compound having a skeleton derived from dipentaerythritol, a (meth)acrylate compound having a skeleton derived from trimethylol propane, or a (meth)acrylate compound having a skeleton derived from ditrimethylol propane. It is even more preferable to include a (meth)acrylate compound having a skeleton derived from ditrimethylol propane.

Herein, as for the “(meth)acrylate compound having a skeleton derived from . . . ”, an explanation will be made taking the (meth)acrylate compound having a skeleton derived from ditrimethylol propane as an example. The (meth)acrylate having a skeleton derived from ditrimethylol propane means an esterified product of ditrimethylol propane and (meth)acrylic acid. The esterified product includes compounds obtained by modifying an alkylene oxy group. It is preferred that the maximum number of ester bonds in a single molecule of the esterified product mentioned above be 4. However, it is also possible that compounds having 1 to 3 ester bonds may be mixed therein.

When a monomer having at least three polymerizable ethylenically unsaturated groups in a single molecule is used in combination with a monofunctional vinyl monomer or a bifunctional vinyl monomer, although no specific limitations are imposed on the use amount, from the viewpoint of improving photo curability and prevention of electrode corrosion, the ratio of a monomer having at least three polymerizable ethylenically unsaturated groups in a molecule is preferably 30 parts by mass or more, more preferably 50 parts by mass or more, and even more preferably 75 parts by mass or more, relative to 100 parts by mass of the total amount of the photopolymerizable compounds contained in the photosensitive resin composition.

As for the contents of the component (A) and the component (B), the content of the component (A) is preferably 35 to 85 parts by mass, more preferably 40 to 80 parts by mass, even more preferably 50 to 70 parts by mass, and particularly preferably 55 to 65 parts by mass relative to 100 parts by mass of the total contents of the component (A) and the component (B). In particular, from the viewpoint of maintaining pattern-forming property or transparency of a cured film, the content of the component (A) is preferably 35 parts by mass or more, more preferably 40 parts by mass or more, even more preferably 50 parts by mass or more, and particularly preferably 55 parts by mass or more relative to 100 parts by mass of the total amount of the component (A) and the component (B).

As the component (C), conventionally known ones can be used without any particular limitation as long as they are a photopolymerization initiator having high transparency. However, from the viewpoint of forming a thin resin cured film pattern, which has thickness that is as low as 10 μm or less, with a sufficient resolution on a substrate, it is preferred that an oxime ester compound is contained.

As the oxime ester compound, a compound represented by the following formula (1), a compound represented by the following formula (2), or a compound represented by the following formula (3) is preferable.

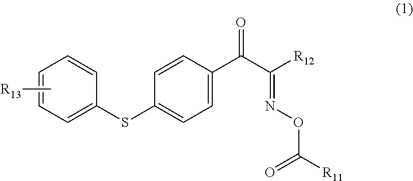

In the formula (1), it is preferred that R₁₁ and R₁₂ each represent an alkyl group having 1 to 12 carbon atoms, a cycloalkyl group having 4 to 10 carbon atoms, a phenyl group, or a tolyl group. R₁₁ and R₁₂ are preferably an alkyl group having 1 to 8 carbon atoms, a cycloalkyl group having 4 to 6 carbon atoms, a phenyl group, or a tolyl group, more preferably an alkyl group having 1 to 4 carbon atoms, a cycloalkyl group having 4 to 6 carbon atoms, a phenyl group, or a tolyl group, and even more preferably a methyl group, a cyclopentyl group, a phenyl group, or a tolyl group. R₁₃ represents —H, —OH, —COOH, —O(CH₂)OH, —O(CH₂)₂OH, —COO(CH₂)OH, or —COO(CH₂)₂OH. R₁₃ is preferably —H, —O(CH₂)OH, —O(CH₂)₂OH, —COO(CH₂)OH, or —COO(CH₂)₂OH, and more preferably —H, —O(CH₂)₂OH, or —COO(CH₂)₂OH.

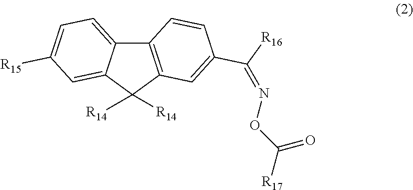

In the formula (2), R₁₄ each represents an alkyl group having 1 to 6 carbon atoms, and it is preferably a propyl group. R₁₅ represents NO₂ or ArCO (in which Ar represents a substituted or unsubstituted aryl group). As the Ar, a tolyl group is preferable. As the substituent group for a case having a substituent group, an alkyl group having 1 to 6 carbon atoms can be mentioned.

R₁₆ and R₁₇ each represent an alkyl group having 1 to 12 carbon atoms, a phenyl group, or a tolyl group. It is preferably a methyl group, a phenyl group, or a tolyl group.

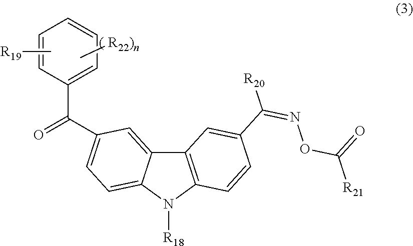

In the formula (3), R₁₈ represents an alkyl group having 1 to 6 carbon atoms, with an ethyl group being preferable.

R₁₉ is an organic group having an acetal bond, and is preferably a substituent group which corresponds to R₁₉ contained in a compound represented by the formula (3-1) described in the followings.

R₂₀ and R₂₁ each represent an alkyl group having 1 to 12 carbon atoms, a phenyl group, or a tolyl group. R₂₀ and R₂₁ are preferably a methyl group, a phenyl group, or a tolyl group, with a methyl group being more preferable.

R₂₂ represents an alkyl group having 1 to 6 carbon atoms. n represents an integer of from 0 to 4.

As the compound represented by the formula (1), a compound represented by the following formula (1-1) and a compound represented by the following formula (1-2) can be mentioned, for example. The compound represented by the following formula (1-1) can be obtained as IRGACURE OXE-01 (manufactured by BASF, product name).

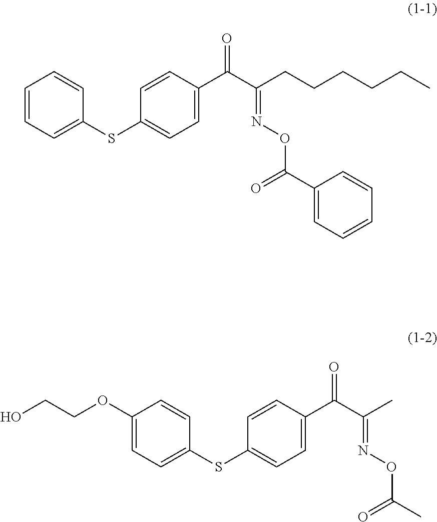 [SMILES: CCCCCC/C(=N\OC(=O)c1ccccc1)C(=O)c1ccc(Sc2ccccc2)cc1 ; CC(=O)O/N=C(\C)C(=O)c1ccc(Sc2ccc(OCCO)cc2)cc1]

As the compound represented by the above formula (2), a compound represented by the following formula (2-1) can be mentioned, for example. The compound represented by the following formula (2-1) can be obtained as DFI-091 (manufactured by Daito Chemix Co., Ltd., product name).

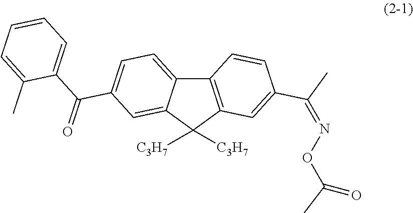

As the compound represented by the above formula (3), a compound represented by the following formula (3-1) can be mentioned, for example. The compound represented by the following formula (3-1) can be obtained as Adeka Optomer-N-1919 (manufactured by Adeka Corporation, product name).

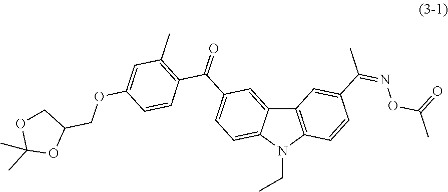 [SMILES: CCn1c2ccc(C(=O)c3ccc(OCC4COC(C)(C)O4)cc3C)cc2c2cc(/C(C)=N\OC(C)=O)ccc21]

As other oxime ester compounds, it is preferable to use a compound represented by the following formula (4) or a compound represented by the following formula (5).

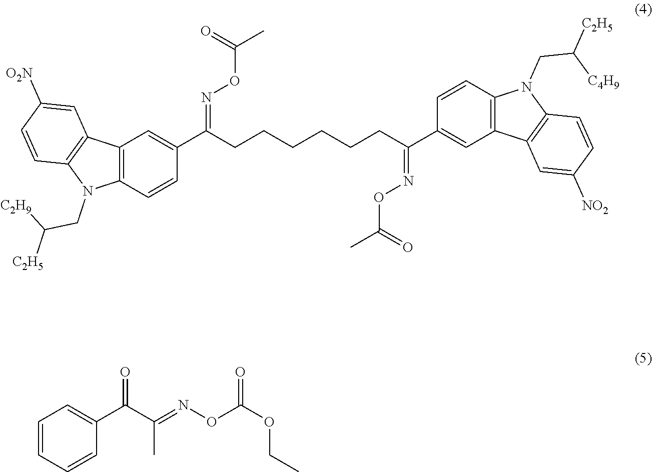

The content of the component (C) is, from the viewpoint of having excellent light sensitivity and resolution, preferably 0.1 to 10 parts by mass, more preferably 1 to 5 parts by mass, even more preferably 1 to 3 parts by mass, and particularly preferably 1 to 2 parts by mass, relative to 100 parts by mass of the total content of the component (A) and the component (B).

From the viewpoint of further improving the rust prevention property of the protective film, it is preferred that the photosensitive resin composition of the present invention further includes a triazole compound having a mercapto group, a tetrazole compound having a mercapto group, a thiadiazole compound having a mercapto group, a triazole compound having an amino group or a tetrazole compound having an amino group (hereinbelow, also referred to as the component (D)).

As the triazole compound having a mercapto group, 3-mercapto-triazole (manufactured by Wako Pure Chemical Co., Ltd., product name: 3MT) can be mentioned, for example.

Furthermore, as the thiadiazole compound having a mercapto group, 2-amino-5-mercapto-1,3,4-thiazole (manufactured by Wako Pure Chemical Co., Ltd., product name: ATT) can be mentioned, for example.

As the aforementioned triazole compound having an amino group, benzotriazole, 1H-benzotriazole-1-acetonitrile, benzotriazole-5-carboxyic acid, 1H-benzotriazole-1-methanol, a compound obtained by substitution of an amino group on carboxybenzotriazole, etc., a compound obtained by substitution of an amino group on a triazole compound having a mercapto group such as 3-mercaptotriazole and 5-mercaptotriazole, or the like can be mentioned.

As the aforementioned tetrazole compound having an amino group, 5-amino-1H-tetrazole, 1-methyl-5-amino-tetrazole, 1-methyl-5-mercapto-1H-tetrazole, 1-carboxymethyl-5-amino-tetrazole, or the like can be mentioned. These tetrazole compounds may be water soluble salts thereof. Specific examples thereof include salts of an alkali metal including sodium, potassium, lithium, or the like such as 1-methyl-5-amino-tetrazole.

In case of containing the component (D), the content thereof is preferably 0.05 to 5.0 parts by mass, more preferably 0.1 to 2.0 parts by mass, even more preferably 0.2 to 1.0 part by mass, and particularly preferably 0.3 to 0.8 part by mass, relative to 100 parts by mass of the total content of the component (A) and the component (B).

From the viewpoint of having adhesiveness to an ITO electrode and preventing residues after development, it is preferred that the photosensitive resin composition according to this embodiment contains a phosphoric acid ester including a photopolymerizable unsaturated bond (hereinbelow, also referred to as the component (E)).

As the phosphoric acid ester including a photopolymerizable unsaturated bond as the component (E), from the viewpoint of attaining both adhesiveness to an ITO electrode and development property at a high level while sufficiently ensuring rust prevention property of a protective film to be formed, Phosmer series manufactured by Uni-Chemical Co., Ltd. (Phosmer-M, Phosmer-CL, Phosmer-PE, Phosmer-MH, Phosmer-PP or the like) or KAYAMER series manufactured by Nippon Kayaku Co., Ltd. (PM21, PM-2 or the like) are preferable.

The refractive index at 633 μm of the photosensitive resin layer is generally 1.40 to 1.49.

The thickness of the photosensitive resin layer is preferably 1 to 30 μm or so.

(High Refractive Index Layer)

The “high” in the high refractive index layer means that the refractive index is higher than the aforementioned photosensitive resin layer.

The high refractive index layer mentioned above has a refractive index at 633 nm of preferably 1.50 to 1.90, more preferably 1.53 to 1.85, and even more preferably 1.55 to 1.75. By allowing the refractive index at 633 nm of the high refractive index layer to be 1.50 to 1.90, when a laminate illustrated in FIG. 2 is prepared, the refractive index becomes a value that is intermediate between a refractive index of a transparent electrode pattern 50a of ITO or the like and a refractive index of various members (for example, OCA for adhering cover glass used for preparing it as a module and a transparent electrode pattern) used on the photosensitive resin layer 20, and thus it becomes possible to decrease difference in color caused by optical reflection between a part in which transparent electrode patterns like ITO are formed and a part in which transparent electrode patterns like ITO are not formed, and thus the “visible skeleton phenomenon” can be suppressed. In addition, the intensity of reflected light of the entire screen can be lowered, and thus a decrease in the transmittance on the screen can be suppressed. Furthermore, the refractive index can be measured with reference to Examples of the specification.

The refractive index of the transparent electrode such as ITO is preferably 1.80 to 2.10, and more preferably 1.85 to 2.05, with 1.90 to 2.00 being even more preferable. In addition, the refractive index of members such as OCA is preferably 1.45 to 1.55, more preferably 1.47 to 1.53, and even more preferably 1.48 to 1.51.

The film thickness of the high refractive index layer mentioned above is preferably 50 to 500 nm, more preferably 60 to 300 nm, even more preferably 70 to 250 nm, and particularly preferably 80 to 200 nm. By allowing the film thickness to be 50 to 500 nm, the intensity of reflected light of the entire screen mentioned above can be further lowered.

The high refractive index layer contains zirconium oxide and tin oxide, or contains zirconium oxide and silica. By containing those components, it becomes possible to enhance the transparency and refractive index at a wavelength of 633 nm of the high refractive index layer at the time of preparing a transfer type photosensitive film for refractive index modulation. Furthermore, as the problems like undesired adhesion onto a substrate or the like are suppressed, the development property can be improved.

The high refractive index layer may contain zirconium oxide, tin oxide, and silica.

From the viewpoint of suppressing the visualization of the transparent conductive pattern, the zirconium oxide is preferably zirconium oxide nano particles (colloid particles of the like). Furthermore, among zirconium oxide nano particles, those having a particle size distribution Dmax of 40 nm or less are preferable.

Zirconium oxide nano particles can be commercially obtainable as OZ-S30K (product name: manufactured by Nissan Chemical Industries, Limited), OZ-S30M (product name: manufactured by Nissan Chemical Industries, Limited), OZ-S40K-AC (manufactured by Nissan Chemical Industries, Limited, product name), SZR-K (methyl ethyl ketone dispersion liquid of zirconium oxide, manufactured by Nissan Chemical Industries, Limited, product name), or SZR-M (methanol dispersion liquid of zirconium oxide, manufactured by Sakai Chemical Industry Co., Ltd., product name).

As the tin oxide, from the viewpoint of suppressing the visualization of a transparent conductive pattern, tin oxide nano particles (colloid particles or the like) are preferable. Furthermore, those having a particle size distribution Dmax of 40 nm or less are preferable.

The tin oxide nano particles are commercially obtainable as OZ-S30K (manufactured by Nissan Chemical Industries, Limited, product name) or OZ-S30M (manufactured by Nissan Chemical Industries, Limited, product name).

As the silica, amorphous silica is preferable. Furthermore, from the viewpoint of suppressing the visualization of a transparent conductive pattern, silica nano particles (colloid particles or the like) are preferable. Furthermore, those having a particle size distribution Dmax of 40 nm or less are preferable.

The silica nano particles are commercially obtainable as OZ-S30K (manufactured by Nissan Chemical Industries, Limited, product name).

Furthermore, it is also possible to use yttrium oxide in combination in the high refractive index layer. Accordingly, it becomes possible to further enhance the transparency and refractive index of the high refractive index layer at the time of preparing a transfer type photosensitive film for refractive index modulation. Furthermore, from the viewpoint of suppressing the visualization of a transparent conductive pattern, yttrium oxide nano particles (colloid particles or the like) are preferable. Furthermore, those having a particle size distribution Dmax of 40 nm or less are preferable.

The yttrium oxide nano particles are commercially obtainable as SZR-K (manufactured by Sakai Chemical Industry Co., Ltd., product name) or SZR-M (manufactured by Sakai Chemical Industry Co., Ltd., product name).

Furthermore, inclusion of zirconium oxide or tin oxide can be specified by detection and mapping of a zirconium element, an oxygen element, or a tin element by using STEM-EDX. The same holds true for silica and yttrium oxide.

The particle size distribution Dmax is measured by using a dynamic light scattering method or a transmission type electron microscope.

The content of the aforementioned components (zirconium oxide, tin oxide, silica, yttrium oxide: hereinbelow, also referred to as component (F)) is preferably 20 to 95 parts by mass, more preferably 50 to 95 parts by mass, and even more preferably 70 to 95 parts by mass, relative to 100 parts by mass of the total components contained in the high refractive index layer.

As the content is within range, the refractive index at 633 nm of the high refractive index layer can be easily adjusted to a range of 1.5 to 1.9, and therefore desirable.

The high refractive index layer may contain, in addition to the component (F), the aforementioned components (A) to (E), if necessary.

The high refractive index layer may substantially consist only of the component (F) and, optionally, the components (A) to (E). It may consist only of the component (F) and, optionally, the components (A) to (E).

The term “substantially” means that 95% by mass or more and 100% by mass or less (preferably 98% by mass or more and 100% by mass or less) of the layer-constituting components are the aforementioned components.

It is possible that that the high refractive index layer has a composition which does not include a compound having a triazine ring. It is also possible that that the high refractive index layer has a composition which does not include a compound having an isocyanuric acid skeleton.

The high refractive index layer may be formed of a composition containing the aforementioned components (high refractive index layer composition).

The high refractive index layer composition contains the component (F) preferably at 20 to 95 parts by mass, more preferably at 50 to 95 parts by mass, and even preferably at 70 to 95 parts by mass relative to 100 parts by mass of the high refractive index layer composition.

Furthermore, the aforementioned “high refractive index layer composition” means a composition which is in a state of not containing any solvent, and the content ratio of each component indicates content ratio relative to the total amount of the components other than solvent.

As described above, it is also possible that 95% by mass or more and 100% by mass or less (preferably 98% by mass or more and 100% by mass or less) of the components constituting the high refractive index layer composition are the aforementioned components, namely, the component (F) and, optionally, the components (A) to (E).

With regard to the transfer type photosensitive film for refractive index modulation, the minimum value of the visible ray transmittance at 400 to 700 nm of a laminate of the photosensitive resin layer and the high refractive index layer is preferably 90.00% or higher, more preferably 90.50% or higher, and even more preferably 90.70% or higher. If the transmittance for visible rays with a wavelength of 400 to 700 nm, which is a common visible ray wavelength region, is 90.00% or higher, when a transparent electrode in a sensing region of a touch panel (touch sensor) is protected, a decrease in image display quality, shade and luminance in a sensing region can be sufficiently suppressed. The maximum value of the visible ray transmittance is 100% or less in general. Furthermore, the visible ray transmittance can be measured with reference to Examples of the specification of the present application.

The photosensitive resin layer 20 and the high refractive index layer 30 of the transfer type photosensitive film for refractive index modulation can be formed by preparing a coating liquid containing a photosensitive resin composition and a high refractive index composition, and then applying this liquid respectively to the supporting film 10 and the protective film 40, followed by drying to allow them to adhere to each other. Alternatively, it can be formed by applying a coating liquid containing a photosensitive resin composition on the supporting film 10, followed by drying. Thereafter, on the photosensitive resin layer 20, a coating liquid containing a high refractive index composition is applied, dried, followed by adhesion of the protective film 40.

The coating liquid can be obtained by uniformly dissolving or dispersing, in a solvent, each component constituting the photosensitive resin composition and the high refractive index composition according to the present embodiment mentioned above.

The solvent used as a coating liquid is not particularly limited, and known solvents can be used. Specific examples thereof include acetone, methyl ethyl ketone, methyl isobutyl ketone, toluene, methanol, ethanol, propanol, butanol, methylene glycol, ethylene glycol, propylene glycol, ethylene glycol monomethyl ether, ethylene glycol monoethyl ether, diethylene glycol dimethyl ether, diethylene glycol ethyl methyl ether, diethylene glycol diethyl ether, propylene glycol monomethyl ether, ethylene glycol monobutyl ether acetate, diethylene glycol monoethyl ether acetate, propylene glycol monomethyl ether acetate, chloroform, and methylene chloride.

As the coating method, doctor blade coating method, meyer bar coating method, roll coating method, screen coating method, spinner coating method, ink jet coating method, spray coating method, dip coating method, gravure coating method, curtain coating method, die coating method or the like can be mentioned.

There are no specific limitations imposed on drying conditions. However, the drying temperature is preferably 60 to 130° C., and the drying time is preferably 0.5 to 30 minutes.

The total thickness of the photosensitive resin layer and the high refractive index layer (hereinbelow, also referred to as a photosensitive refractive index modulating layer) is preferably 30 μm or less, more preferably 20 μM or less, and even more preferably 10 μm or less, from the viewpoint of followability at the time of lamination. Furthermore, from the viewpoint of the rust prevention property and considering the possibility of having an occurrence of a pin hole as caused by protrusions on a substrate, the total thickness is preferably 1 μm or more, more preferably 2 μm or more, and even more preferably 2 μm or more. As the total thickness is 3 μm or more, an influence of the protrusions on a substrate is suppressed at maximum level, and thus it becomes possible to maintain the rust prevention property.

The viscosity of the photosensitive refractive index modulating layer at 30° C. is preferably 15 to 100 mPa·s, more preferably 20 to 90 mPa·s, and even more preferably 25 to 80 mPa·s, from the viewpoint of suppressing a resin composition from oozing out from an end surface of a transfer type photosensitive film for refractive index modulation when the transfer type photosensitive film for refractive index modulation is stored in roll form and from the viewpoint of suppressing adhesion of pieces of a resin composition to a substrate when a transfer type photosensitive film for refractive index modulation is cut.

As the protective film 40, polyethylene, polypropylene, polyethylene terephthalate, polycarbonate, a polyethylene-vinyl acetate copolymer, a laminate film of a polyethylene-vinyl acetate copolymer and polyethylene or the like can be mentioned.

The thickness of the protective film 40 is preferably 5 to 100 μm. However, from the viewpoint of storing after winding it in the form of a roll, the thickness thereof is preferably 70 μm or less, more preferably 60 μm or less, even more preferably 50 μm or less, and particularly preferably 40 μm or less.

Next, an explanation will be given for a method for forming a cured film by using the transfer type photosensitive film for refractive index modulation.

First, after removing a protective film 40 of a transfer type photosensitive film for refractive index modulation 1, the transfer type photosensitive film for refractive index modulation is laminated (transferred) according to crimping to the surface of a substrate 50 (substrate adhered with transparent conductive pattern) from a high refractive index layer 30. As the crimping means, a crimping roll can be mentioned. A crimping roll may be provided with a heating means so as to have crimping with heating.

As for the heating temperature when crimping with heating is carried out, from the viewpoint of the adhesiveness of the high refractive index layer 30 and the substrate 50 and also from the viewpoint of allowing components constituting the photosensitive resin layer or the high refractive index layer to be hardly cured or decomposed by heating, the heating temperature is preferably 10 to 160° C., more preferably 20 to 150° C., and even more preferably 30 to 150° C.

Furthermore, as for the crimping pressure when crimping with heating is carried out, from the viewpoint of suppressing deformation of the substrate 50 while fully ensuring the adhesiveness of the high refractive index layer 30 and the substrate 50, a linear pressure is preferably 50 to 1×10⁵ N/m, more preferably 2.5×10² to 5×10⁴ N/m, and even more preferably 5×10² to 4×10⁴ N/m.

Preheating of the substrate is not necessarily required if the transfer type photosensitive film for refractive index modulation is crimped with heating as mentioned above. However, from the viewpoint of further enhancing the adhesiveness between the high refractive index layer 30 and the substrate 50, the substrate 50 may be subjected to preheating. At that time, the treatment temperature is preferably 30 to 150° C.

As the substrate, substrates such as a glass plate, a plastic plate and a ceramic plate that are used in a touch panel (touch sensor) can be mentioned, for example. On the substrate, an electrode on which a cured film is formed is disposed. As the electrode, an electrode such as ITO, Cu, Al and Mo can be mentioned. On the substrate, an insulating layer may be disposed between the substrate and the electrode.

Next, a predetermined part of the transferred photosensitive refractive index modulating layer after transfer is irradiated with active rays through a photomask to have a pattern shape. When irradiating active rays, if the supporting film 10 on the photosensitive refractive index modulating layer is transparent, it can be irradiated directly with active rays. If the supporting film 10 is not transparent, irradiation of active rays is carried out after removing the supporting film. As the light source of active rays, known sources of active rays can be used.

The irradiation amount of active rays is 1×10² to 1×10⁴ J/m². At the time of irradiation, heating can be simultaneously carried out. If the irradiation amount of the active rays is 1×10² J/m² or more, photo-curing can be sufficiently proceeded. If the irradiation amount is 1×10⁴ J/m² or less, there is a tendency that discoloration of the photosensitive refractive index modulating layer is suppressed.

Subsequently, an unexposed part of the photosensitive resin layer and the high refractive index layer after irradiation of active rays is removed by a developing liquid, and a refractive index modulating pattern that covers part or all of the transparent electrode is formed. If the supporting film 10 is stacked on the photosensitive refractive index modulating layer after irradiation of active rays, the development step is carried out after removing it. Furthermore, the refractive index modulating pattern can be a pattern which follows the electrode pattern, or it may be a pattern having a shape which corresponds to a substrate after removing the outer peripheral part thereof. In the latter case, if the substrate has an almost rectangular shape, for example, the refractive index modulating pattern becomes to have a pattern of almost rectangular shape.

The development step can be carried out by known methods such as spraying, showering, immersion swinging, brushing and scrapping with use of a known developing liquid such as an aqueous alkaline solution, an aqueous solution, or an organic solvent. Among these methods, development by spraying by using an aqueous alkaline solution is preferable from the viewpoint of environment and safety. Furthermore, the temperature or time of development can be adjusted within a conventionally known range.

An electronic component according to the present embodiment is provided with a refractive index modulating pattern formed by using a transfer type photosensitive film for refractive index modulation. As the electronic component, a touch panel, a liquid crystal display, an organic electronic luminescence device, a solar battery module, a print circuit board, electronic paper or the like can be mentioned.

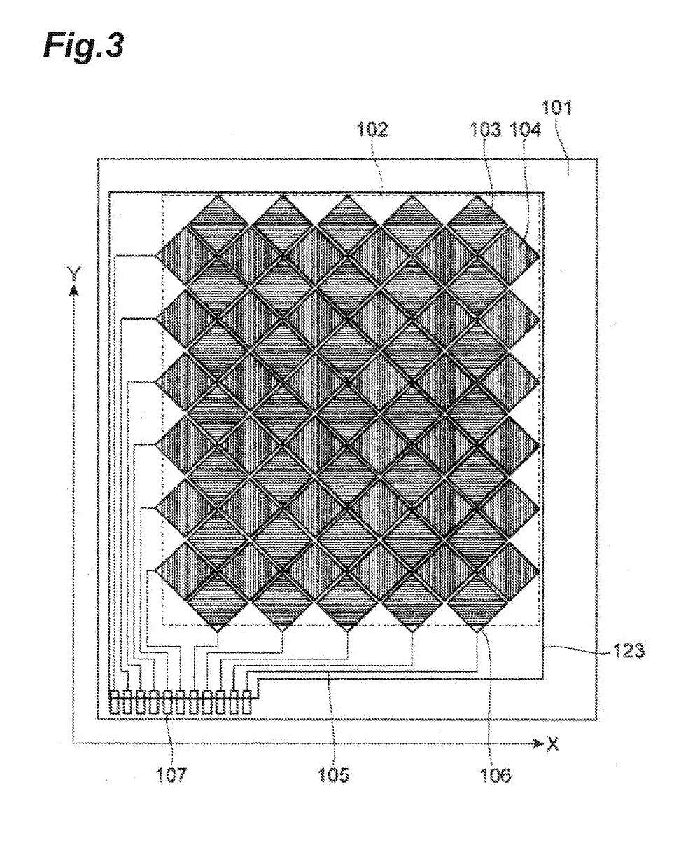

FIG. 3 is a schematic top view illustrating one example of a capacitive touch panel. The touch panel illustrated in FIG. 3 has a touch screen 102 for detecting touch position coordinates on one side of a transparent substrate 101. A transparent electrode 103 and a transparent electrode 104 are disposed on the substrate 101 in order to detect a change in capacitance in this region.

The transparent electrode 103 and the transparent electrode 104 respectively detect the X-position coordinate and the Y-position coordinate of the touch position.

On the transparent substrate 101, a lead-out wiring 105 for transmitting detected signals at the touch position from the transparent electrode 103 and the transparent electrode 104 to external circuits is provided. Furthermore, the lead-out wiring 105, the transparent electrode 103 and the transparent electrode 104 are connected by a connection electrode 106 provided on the transparent electrode 103 and the transparent electrode 104. Furthermore, on an end part opposite to the connection part of the transparent electrode 103 and the transparent electrode 104 of the lead-out wiring 105, a connection terminal 107 for connection with external circuits is provided.

As illustrated in FIG. 3, by forming a refractive index modulating pattern 123, a function as a protective film of the transparent electrode 103, the transparent electrode 104, the lead-out wiring 105, the connection electrode 106, and the connection terminal 107, and a function of modulating the refractive index of a sensing region (touch screen 102) formed of the transparent electrode pattern are exhibited simultaneously.

### EXAMPLES

Hereinbelow, the present invention will be explained more specifically with reference to Examples. However, the present invention is not limited to the following Examples.

### Examples 1 to 6 and Comparative Examples 1 to 7

[Preparation of Binder Polymer Solution (A1)]

To a flask provided with a stirrer, a reflux condenser, an inert gas introduction port and a thermometer, (1) shown in Table 1 was added, and heated to 80° C. under a nitrogen gas atmosphere. While keeping the reaction temperature at 80° C.±2° C., (2) shown in Table 1 was added dropwise homogenously for 4 hours. After dropwise addition of (2), stirring was continued at 80° C.±2° C. for 6 hours, and thus a solution (solid matter content: 45% by mass) (A1) of a binder polymer having a weight average molecular weight of 65,000, an acid value of 78 mgKOH/g and a hydroxyl value of 2 mgKOH/g was obtained.

TABLE 1

| | | Blending amount |
|---|---|---|
| | | (parts by mass) |
| | | (A1) |
| (1) | Propylene glycol monomethyl ether | 62 |
| | Toluene | 62 |
| (2) | Methacrylic acid | 12 |
| | Methyl methacrylate | 58 |
| | Ethyl acrylate | 30 |
| | 2,2′-Azobis(isobutyronitrile) | 1.5 |

| | |
|---|---|
| Weight average molecular weight | 65,000 |
| Hydroxyl value (mgKOH/g) | 2 |
| Acid value (mgKOH/g) | 78 |
| Tg (° C.) | 60 |

[Method for Measuring Weight Average Molecular Weight]

The weight average molecular weight (Mw) was measured by gel permeation chromatography (GPC) and calculated based on conversion using a calibration curve of standard polystyrene. Conditions of GPC are shown below.

### <GPC Conditions>

Pump: L-6000 (manufactured by Hitachi, Ltd., product name)
Column: Gelpack GL-R420, Gelpack GL-R430, Gelpack GL-R440 (all are manufactured by Hitachi Chemical Company, Ltd., product name)

### Eluent: Tetrahydrofuran

Measurement temperature: 40° C.
Flow rate: 2.05 mL/minute
Detector: L-3300 (RI detector, manufactured by Hitachi, Ltd., product name)

[Method for Measuring Acid Number]

The binder polymer solution was heated at 130° C. for 1 hour, and volatile matters were removed to obtain solid matter. Then, 1 g of this solid matter polymer was precisely weighed. 30 g of acetone was added to this polymer, and the polymer was uniformly dissolved therein. Subsequently, an appropriate amount of phenolphthalein as an indicator was added thereto, and titration was carried out by using a 0.1 N KOH aqueous solution. An acid value was calculated by the following formula:

Acid number=0.1×Vf×56.1/(Wp×I/100)

In the formula, Vf represents a titration amount (mL) of an aqueous solution of KOH, Wp represents a mass (g) of the resin solution measured, and I represents a ratio (% by mass) of non-volatile matters in the resin solution measured.

[Method for Measuring Hydroxyl Value]

The binder polymer solution was heated at 130° C. for 1 hour, and volatile matters were removed to obtain solid matter. 1 g of the solid matter polymer was precisely weighed, and the polymer was put in an Erlenmeyer flask. 10 mL of a 10% by mass pyridine solution of acetic anhydride was added, was uniformly dissolved, and heated at 100° C. for 1 hour. After the heating, 10 mL of water and 10 mL of pyridine were added, and heated at 100° C. for 10 minutes. Thereafter, by using an automatic titrator (manufactured by Hiranuma Sangyo Co., Ltd., product name: COM-1700), neutralization titration was carried out with 0.5 mol/L of an ethanol solution of potassium hydroxide. The hydroxyl value was calculated by the following formula:

Hydroxyl value=(A−B)×f×28.05/Sample (g)+Acid value

In the formula, A represents the amount (mL) of the 0.5 mol/L-ethanol solution of potassium hydroxide used for a blank test, B represents the amount (mL) of the 0.5 mol/L-ethanol solution of potassium hydroxide used for titration, and f represents a factor.

[Preparation of Coating Liquid for Forming Photosensitive Resin Layer]

Each component shown in Table 2 was mixed for 15 minutes by using a stirrer, and thus a coating liquid (composition) A for forming a photosensitive resin layer was prepared.

In Table 2, unit of the blending amount of each component is parts by mass.

TABLE 2

| | | Composition of |
|---|---|---|
| | | composition A |
| | | (parts by mass) |
| Component (A) | A1 | 60 |
| Component (B) | T-1420(T) | 40 |
| Component (C) | IRGACURE OXE 01 | 1.7 |
| Component (D) | HAT | 0.4 |
| Component (E) | PM-21 | 0.5 |
| Others | Antage W-500 | 0.1 |
| | SH-30 | 0.07 |
| | Methyl ethyl ketone | 50 |

The symbols for the components in Table 2 have the following meaning.
Component (A)
   (A1): A propylene glycol monomethyl ether/toluene solution of a copolymer having a monomer blending ratio (methacrylic acid/methyl methacrylate/ethyl acrylate=12/58/30 (mass ratio)), weight average molecular weight 65,000, acid value 78 mgKOH/g, hydroxyl value 2 mgKOH/g, Tg 60° C.
Component (B)
   T-1420 (T): Ditrimethylol propane tetraacrylate (manufactured by Nippon Kayaku Co., Ltd., product name)
Component (C)
   IRGACURE OXE 01: 1,2-Octanedione, 1-[(4-phenylthio)phenyl-, 2-(O-benzoyloxime)] (manufactured by BASF, product name)
Component (D)

HAT: 5-Amino-1H-tetrazole (manufactured by Toyobo Co., Ltd., product name)
Component (E)

PM-21: Phosphoric acid ester including a photopolymerizable unsaturated bond (manufactured by Nippon Kayaku Co., Ltd., product name)
Other components
   Antage W-500 (AW-500): 2,2′-Methylene-bis(4-ethyl-6-tert-butylphenol) (manufactured by Kawaguchi Chemical Industry Co., Ltd., product name)
   SH-30: Octamethylcyclotetrasiloxane (manufactured by Dow Corning Toray Co., Ltd., product name)
   Methyl ethyl ketone (manufactured by Tonen Chemical Corporation)

[Preparation of Coating Liquid for Forming High Refractive Index Layer]

The components in the “high refractive index layer” in Table 3 and Table 4 that are described below were mixed for 15 minutes by using a stirrer, and thus a coating liquid for forming a high refractive index layer was prepared. Unit of the blending amount of each component is parts by mass.

The symbols for the components in Tables 3 and 4 have the following meaning.
Component (B)
   BPE1300: Ethoxylated bisphenol A dimethacrylate (manufactured by Shin Nakamura Co., Ltd., product name)
Component (F)
   OZ-S30K: Zirconia dispersion liquid (manufactured by Nissan Chemical Industries, Ltd., product name: NanoUse OZ-S30K, including tin oxide colloid particles and silica colloid particles)
   OZ-S30M: Zirconia dispersion liquid (manufactured by Nissan Chemical Industries, Ltd., product name: NanoUse OZ-S30M, including tin oxide colloid particles)
   ZR-010: Zirconia dispersion (manufactured by Solar Co., Ltd., product name: NANO5 ZR-010)
   ZR-020: Zirconia dispersion (manufactured by Solar Co., Ltd., product name: NANO5 ZR-020)
   ZRPMA20WT %-E05: Zirconia dispersion (manufactured by CIK Nano Tek Corporation, product name: ZRPMA20WT %-E05)
   ZRPMIBK20WT %-P02: Zirconia dispersion (manufactured by CIK Nano Tek Corporation, product name: ZRPMIBK20WT %-P02)
   ZRPGM20WT %-F57: Zirconia dispersion (manufactured by CIK Nano Tek Corporation, product name: ZRPGM20WT %-F57)
   SZR-M: Zirconia dispersion (manufactured by Sakai Chemical Industry Co., Ltd., product name: SZR-M)
   SZR-K: Zirconia dispersion (manufactured by Sakai Chemical Industry Co., Ltd., product name: SZR-K)
Other Components
   B6030: 5-Amino-1Htetrazole (manufactured by Chiyoda Chemical Co., Ltd., product name)
   L-7001: Octamethylcyclotetrasiloxane (manufactured by Dow Corning Toray Co., Ltd., product name)

[Measurement of Refractive Index]

A coating liquid for forming the high refractive index layer prepared above was uniformly applied onto a 0.7 mm thick glass substrate by means of a spin coater, and dried by a hot air retention type dryer of 100° C. for 3 minutes to remove the solvent, and thus a high refractive index layer was formed.

Subsequently, the high refractive index layer obtained above was irradiated with ultraviolet rays with an exposure amount of 5×10² J/m² (measured value at 365 nm) by using a parallel light exposure apparatus (EXM1201 manufactured by Orc Manufacturing Co., Ltd.). Then, the layer was left in a box type dryer (model: NV50-CA manufactured by Mitsubishi Electric Corporation) heated at 140° C. for 30 minutes, and thus a sample having the high refractive index layer for measuring the refractive index was obtained.

Subsequently, for the obtained sample for measuring the refractive index, the refractive index at 633 nm was measured by means of ETA-TCM (manufactured by AudioDev GmbH).

Furthermore, according to the form of a transfer type photosensitive film for refractive index modulation, it is difficult to measure the refractive index of just a single layer of the refractive index layer. Therefore, the refractive index is a refractive index value of the outermost layer on the side of the supporting film of the high refractive index layer.

The refractive index of each high refractive index layer is shown in Tables 5 and 6.

[Preparation of Transfer Type Photosensitive Film for Refractive Index Modulation]

As the protective film, a 30 μm thick polypropylene film (manufactured by Oji F-Tex Co., Ltd, product name: E-201F) was used. The coating liquid prepared above for forming the high refractive index layer was uniformly applied onto a protective film by using a die coater, and dried for 3 minutes in a hot air retention type dryer of 100° C. to remove the solvent, and thus a high refractive index layer was formed.

As the supporting film, a 16 μm thick polyethylene terephthalate film (manufactured by Toray Industries, Inc., product name: FB40) was used. The coating liquid prepared above for forming the photosensitive resin layer was uniformly applied onto a supporting film by using a comma coater, and dried for 3 minutes in a hot air convection type dryer of 100° C. to remove the solvent, and thus a photosensitive resin layer was formed.

[Measurement of Film Thickness of High Refractive Index Layer and Photosensitive Resin Layer]

The film thickness of the high refractive index layer prepared above was measured by means of F20 (manufactured by FILMETRICS, Inc., product name). Furthermore, the film thickness of the photosensitive resin layer prepared above was measured by means of a digital thickness gauge (manufactured by Nikon Corporation, product name: DIGIMICROSTAND MS-5C). The film thickness of the high refractive index layer and photosensitive resin layer is described in Tables 5 and 6.

Subsequently, based on the combination shown in Tables 3 and 4, the protective film having the high refractive index layer and the supporting film having the photosensitive resin layer were adhered to each other at 23° C. by using a laminator (manufactured by Hitachi Chemical Company, Ltd., product name: HLM-3000), and thus a transfer type photosensitive film for refractive index modulation was prepared.

TABLE 3

| | | | Example | | | | | |
|---|---|---|---|---|---|---|---|---|
| | | | 1 | 2 | 3 | 4 | 5 | 6 |
| Photosensitive resin layer | | | A | A | A | A | A | A |
| High refractive | Component | OZ-S30K | 75 | 100 | 170 | — | — | — |
| index layer | (F) | OZ-S30M | — | — | — | 75 | 100 | 170 |
| | Component | A1 | 12.5 | 12.5 | 12.5 | 12.5 | 12.5 | 12.5 |
| | (A) | | | | | | | |
| | Component | BPE1300 | 12.5 | 12.5 | 12.5 | 12.5 | 12.5 | 12.5 |
| | (B) | | | | | | | |
| | Component | PM-21 | 0.5 | 0.5 | 0.5 | 0.5 | 0.5 | 0.5 |
| | (E) | | | | | | | |
| | Others | B6030 | 0.5 | 0.5 | 0.5 | 0.5 | 0.5 | 0.5 |
| | | L-7001 | 3 | 3 | 3 | 3 | 3 | 3 |

TABLE 4

| | | | Comparative Example | | | | | | |
|---|---|---|---|---|---|---|---|---|---|
| | | | 1 | 2 | 3 | 4 | 5 | 6 | 7 |
| Photosensitive resin layer | | | A | A | A | A | A | A | A |
| High | Component | ZR-010 | 100 | | | | | | |
| refractive | (F) | ZR-020 | | 100 | | | | | |
| index layer | | ZRPMA20WT | | | 100 | | | | |
| | | %-E05 | | | | | | | |
| | | ZRMIBK20WT | | | | 100 | | | |
| | | %-P02 | | | | | | | |
| | | ZRPGM20WT | | | | | 100 | | |
| | | %-F57 | | | | | | | |
| | | SZR-M | | | | | | 100 | |
| | | SZR-K | | | | | | | 100 |
| | Component | A1 | 12.5 | 12.5 | 12.5 | 12.5 | 12.5 | 12.5 | 12.5 |
| | (A) | | | | | | | | |
| | Component | BPE1300 | 12.5 | 12.5 | 12.5 | 12.5 | 12.5 | 12.5 | 12.5 |
| | (B) | | | | | | | | |
| | Component | PM-21 | 0.5 | 0.5 | 0.5 | 0.5 | 0.5 | 0.5 | 0.5 |
| | (E) | | | | | | | | |
| | Others | B0630 | 0.5 | 0.5 | 0.5 | 0.5 | 0.5 | 0.5 | 0.5 |
| | | L-7001 | 3 | 3 | 3 | 3 | 3 | 3 | 3 |

The following evaluations were carried out for the prepared transfer type photosensitive film for refractive index modulation. The results are shown in Tables 5 and 6.

[Measurement of Transmittance and Haze of Cured Film]

While peeling off the protective film of the transfer type photosensitive film for refractive index modulation prepared above, on a 0.7 mm thick glass substrate, lamination was carried out by using a laminator (manufactured by Hitachi Chemical Company, Ltd., product name: ELM-3000) such that the high refractive index layer was brought into contact therewith under conditions of roll temperature of 120° C., substrate supply speed of 1 m/min and crimping pressure (cylinder pressure) of 4×10⁵ Pa (since a substrate having a thickness of 1 mm and a length of 10 cm× a width of 10 cm was used, the linear pressure at the time of the lamination was 9.8×10³ N/m), and thus a laminate in which the high refractive index layer, the photosensitive resin layer, and the supporting film are laminated on the glass substrate was prepared.

Subsequently, the obtained laminate was irradiated with UV rays by means of a parallel ray exposure apparatus (product name: EXM1201, manufactured by Oak Manufacturing Co., Ltd.) from the upper side of the photosensitive resin layer with an exposure amount of 5×10² J/m² (measured value at a wavelength of 365 nm). Thereafter, the supporting film was removed, and the laminate was left for 30 minutes in a box type dryer (model: NV50-CA, manufactured by Mitsubishi Electric Corporation) heated at 140° C., and thus a sample for measuring the transmittance was obtained.

Subsequently, for the obtained sample for measuring the transmittance, visible ray transmittance and haze value were measured in a measurement wavelength region of 400 to 700 nm by means of a haze meter (product name: NDH 7000, manufactured by Nippon Denshoku Industries Co., Ltd.).

[Salt Water Spray Test (Test for Evaluating Resistance to Artificial Sweat) for Cured Film)]

While peeling off the protective film of the transfer type photosensitive film for refractive index modulation prepared above, on a polyimide film provided with sputter copper (manufactured by Toray Advanced Film Co., Ltd.), lamination was carried out by using a laminator (manufactured by Hitachi Chemical Company, Ltd., product name: HLM-3000) such that the high refractive index layer was brought into contact therewith under conditions of roll temperature of 120° C., substrate supply speed of 1 m/min and crimping pressure (cylinder pressure) of 4×10⁵ Pa (since a substrate having a thickness of 1 mm, and a length of 10 cm× a width of 10 cm was used, the linear pressure at the time of the lamination was 9.8×10³ N/m), and thus a laminate in which the high refractive index layer, the photosensitive resin layer, and the supporting film are stacked on sputter copper was obtained.

Subsequently, the photosensitive resin layer of the obtained laminate was irradiated with UV rays by means of a parallel ray exposure apparatus (manufactured by Oak Manufacturing Co., Ltd., product name: EXM1201) from the upper side of the photosensitive resin layer with an exposure amount of 5×10² J/m² (measured value at a wavelength of 365 nm). Thereafter, the supporting film was removed, and the laminate was further irradiated with UV rays from the upper side of the photosensitive resin layer with an exposure amount of 1×10⁴ J/m² (measured value at a wavelength of 365 nm). Then, the laminate was left for 30 minutes in a box type dryer (manufactured by Mitsubishi Electric Corporation, model: NV50-CA) heated at 140° C., and thus a sample for evaluating the resistance to artificial sweat was obtained.

Subsequently, in accordance with JIS standards (Z 2371), by using a salt water spray tester (manufactured Suga Test Instrument Co., Ltd., product name: STP-90V2), the sample mentioned above was placed in a test chamber, and salt water having a concentration of 50 g/L (pH=6.7) was sprayed thereto for 48 hours at a test chamber temperature of 35° C. and a spray amount of 1.5 mL/h. After completion of the spraying, the salt water was wiped off, and the surface condition of the sample for evaluation was observed and evaluated in accordance with the following points.

A: Absolutely no change was observed on the surface of the protective film.
B: Very slight marks were observed on the surface of the protective film, but no change was observed in the copper.
C: Slight marks were observed on the surface of the protective film, but no change was observed in the copper.
D: Marks were observed on the surface of the protective film, and discoloration of the copper was shown.

[Test for Development Residues]

While peeling off the protective film of the transfer type photosensitive film for refractive index modulation prepared above, on a PET film adhered with easy adhesion layer (product name A4300, thickness of 125 μm, manufactured by Toyobo Co., Ltd.), lamination was carried out by using a laminator (manufactured by Hitachi Chemical Company, Ltd., product name: FILM-3000) such that the high refractive index layer was brought into contact therewith under conditions of roll temperature of 120° C., substrate supply speed of 1 m/min and crimping pressure (cylinder pressure) of 4×10⁵ Pa (since a substrate having a thickness of 125 μm, and a length of 10 cm× a width of 10 cm was used, the linear pressure at the time of the lamination was 9.8×10³ N/m), and thus a laminate in which the high refractive index layer, the photosensitive resin layer, and the supporting film are stacked on A4300 was obtained.

After preparing the laminate as obtained above, it was stored for 30 minutes at conditions including temperature of 23° C. and humidity of 60%. Then, the supporting film laminated on the photosensitive resin layer was removed, and spray development was carried out at 30° C. for 40 seconds by using a 1.0% by mass aqueous solution of sodium carbonate, and thus the high refractive index layer and photosensitive resin layer were removed. The surface state of the obtained substrate was observed under a microscope, and the development residues were evaluated according to the following points.

A: Absolutely no change was observed on the surface of the substrate.
B: Slight development residues have occurred.
C: Development residues have occurred.

As a result of observing the surface state of the sample for evaluation of Examples, there was absolutely no change on the surface of the surface. Thus, the evaluation was A.

[Measurement of Color Hue (Reflection R)]

While peeling off the protective film of the obtained transfer type photosensitive film for refractive index modulation, on a transparent conductive film (manufactured by Toyobo Co., Ltd., product name: 300R), lamination was carried out by using a laminator (manufactured by Hitachi Chemical Company, Ltd., product name: FILM-3000) such that the high refractive index layer was brought into contact therewith under conditions of roll temperature of 120° C., substrate supply speed of 1 m/min and crimping pressure (cylinder pressure) of 4×10⁵ Pa (since a substrate having a thickness of 1 mm, and a length of 10 cm x a width of 10 cm was used, the linear pressure at the time of the lamination was 9.8×10³ N/m), and thus a laminate in which the high refractive index layer, the photosensitive resin layer, and the supporting film are stacked on the transparent conductive substrate was obtained.

Subsequently, the obtained laminate was irradiated with UV rays by means of a parallel ray exposure apparatus (manufactured by Oak Manufacturing Co., Ltd., product name: EXM1201) from the upper side of the photosensitive resin layer with an exposure amount of 5×10² J/m² (measured value at a wavelength of 365 nm). Thereafter, the supporting film was removed, and thus a sample for measuring color hue (reflection R) having a cured film was obtained.

Subsequently, by using a spectral colorimeter (manufactured by Konica Minolta, Inc., product name: CM-5), the obtained sample for measuring color hue (reflection R) was measured for b* (reflection b*) and Y value (this is taken as the reflectance R) of XYZ color system while the light source is set at the photosensitive resin layer side, light source setting is D65, viewing angle is 2°, and measurement diameter is 30 mmϕ, and based on SCI (including specular light) mode. Then, standardization was made by using the following formula:

Standardization of reflectance R=Actual measured value of reflectance/Actual measured value of reflectance of measurement sample in which only photosensitive resin layer is laminated×100

TABLE 5

| | Example | | | | | |
|---|---|---|---|---|---|---|
| | 1 | 2 | 3 | 4 | 5 | 6 |
| Refractive index of high | 1.61 | 1.62 | 1.63 | 1.62 | 1.63 | 1.64 |
| refractive index layer | | | | | | |
| Film thickness of high | 60 | 60 | 60 | 60 | 60 | 60 |
| refractive index layer (nm) | | | | | | |
| Film thickness of | 8 | 8 | 8 | 8 | 8 | 8 |
| photosensitive resin layer | | | | | | |
| (μm) | | | | | | |
| Salt water spray test | A | A | A | A | A | A |
| Visible ray transmittance (%) | 91.02 | 91.07 | 91.06 | 91.02 | 91.22 | 91.15 |
| Haze | 0.37 | 0.36 | 0.37 | 0.35 | 0.32 | 0.36 |
| Development property | A | A | A | A | A | A |
| Standardization of | 84% | 83% | 82% | 89% | 88% | 88% |
| reflection R | | | | | | |

TABLE 6

| | Comparative Example | | | | | | |
|---|---|---|---|---|---|---|---|
| | 1 | 2 | 3 | 4 | 5 | 6 | 7 |
| Refractive index of high refractive | 1.62 | 1.64 | 1.62 | 1.62 | 1.62 | 1.64 | 1.64 |
| index layer | | | | | | | |
| Film thickness of high refractive | 60 | 60 | 60 | 60 | 60 | 60 | 60 |
| index layer (nm) | | | | | | | |
| Film thickness of photosensitive | 8 | 8 | 8 | 8 | 8 | 8 | 8 |
| resin layer (μm) | | | | | | | |
| Salt water spray test | A | A | A | A | A | A | A |
| Visible ray transmittance (%) | 91.01 | 91.04 | 91.00 | 91.00 | 88.95 | 91.05 | 91.11 |
| Haze | 0.50 | 0.48 | 0.63 | 0.56 | 6.44 | 0.37 | 0.35 |
| Development property | C | C | C | C | B | C | C |
| Standardization of reflection R | 93% | 84% | 87% | 84% | 72% | 94% | 92% |

As shown in Tables 5 and 6, it is found that the transfer type photosensitive film for refractive index modulation of the present invention has an excellent development property. Furthermore, favorable results were also obtained in terms of the salt water spray test, visible ray transmittance, haze, and reflection R standardization.

1. A transfer type photosensitive film for refractive index modulation which comprises a supporting film, a photosensitive resin layer disposed on the supporting film, and a high refractive index layer disposed on the photosensitive resin layer and containing zirconium oxide and tin oxide.

2. A transfer type photosensitive film for refractive index modulation which comprises a supporting film, a photosensitive resin layer disposed on the supporting film, and a high refractive index layer disposed on the photosensitive resin layer and containing zirconium oxide and silica.

3. The transfer type photosensitive film for refractive index modulation according to claim 1, wherein the high refractive index layer contains zirconium oxide, tin oxide, and silica.

4. The transfer type photosensitive film for refractive index modulation according to claim 1, wherein the refractive index at 633 nm of the high refractive index layer is 1.5 to 1.9.

5. The transfer type photosensitive film for refractive index modulation according to claim 1, wherein the film thickness of the high refractive index layer is 50 nm to 500 nm.

6. The transfer type photosensitive film for refractive index modulation according to claim 1, wherein the photosensitive resin layer contains a binder polymer, a photopolymerizable compound, and a photopolymerization initiator.

7. The transfer type photosensitive film for refractive index modulation according to claim 6, wherein the photopolymerization initiator contains an oxime ester compound.

8. The transfer type photosensitive film for refractive index modulation according to claim 6, wherein the binder polymer is a polymer having a carboxy group.

9. The transfer type photosensitive film for refractive index modulation according to claim 6, wherein the binder polymer is a polymer which contains a structural unit derived from a compound selected from (meth)acrylic acid, (meth)acrylic acid glycidyl ester, (meth)acrylic acid benzyl ester, styrene, (meth)acrylic acid methyl ester, (meth)acrylic acid ethyl ester, (meth)acrylic acid butyl ester, and (meth)acrylic acid-2-ethylhexyl ester.

10. The transfer type photosensitive film for refractive index modulation according to claim 1, wherein the photosensitive resin layer contains phosphoric acid ester including a photopolymerizable unsaturated bond.

11. The transfer type photosensitive film for refractive index modulation according to claim 1, wherein the minimum value of visible ray transmittance at 400 to 700 nm of a laminate with the photosensitive resin layer and the high refractive index layer is 90% or higher.

12. The transfer type photosensitive film for refractive index modulation according to claim 1, wherein the total thickness of the photosensitive resin layer and the high refractive index layer is 30 μm or less.

13. A method for forming a refractive index modulating pattern, comprising:
a step of laminating a high refractive index layer and a photosensitive resin layer by using the transfer type photosensitive film for refractive index modulation described in claim 1 such that the high refractive index layer is closely adhered on a substrate, and
a step of exposing predetermined parts of the high refractive index layer and the photosensitive resin layer on the substrate, and removing parts other than the predetermined parts to form a refractive index modulating pattern.

14. A laminate comprising, a high refractive index layer containing zirconium oxide and tin oxide, and a photosensitive resin layer, on a substrate with electrode pattern.

15. A laminate comprising, a high refractive index layer containing zirconium oxide and silica, and a photosensitive resin layer, on a substrate with electrode pattern.

16. An electronic component comprising, a pattern comprising a high refractive index layer containing zirconium oxide and tin oxide, and a pattern comprising a cured film of a photosensitive resin layer, on a substrate with electrode pattern.

17. An electronic component comprising, a pattern comprising a high refractive index layer containing zirconium oxide and silica, and a pattern comprising a cured film of a photosensitive resin layer, on a substrate with electrode pattern.
